(19) United States
(12) Patent Application Publication
(10) Pub. No.: US 2010/0186525 A1
(43) Pub. Date: Jul. 29, 2010

(54) Wheelchair and Method of Security Screening a Wheelchair

(76) Inventors: Chris Mashburn, Lakeway, TX (US); Shannon Conklin, Lakeway, TX (US)

Correspondence Address: WEIDE & MILLER, LTD., 7251 W. LAKE MEAD BLVD., SUITE 530, LAS VEGAS, NV, 89128, US

(21) Appl. No.: 12/359,628

(22) Filed: Jan. 26, 2009

(51) Int. Cl. G01M 17/007; B62M 1/14

(52) U.S. Cl. 73/865.8; 280/250.1

(57) ABSTRACT

An improved wheelchair and a method of security screening a wheelchair are disclosed. The wheelchair is constructed of plastic and includes an antimicrobial agent. The wheelchair also includes a plurality of safety features. In a method, the wheelchair is tested for compliance with safety and security standards. If compliant, the wheelchair is certified by locating certification information on the wheelchair and the wheelchair is provided for use. Before each use, the wheelchair is validated by confirming the existence of the certification information. The wheelchair is then used to transport a user to and through a security checkpoint while the user remains seated in the wheelchair, including as the wheelchair passes through checkpoint screening.

### FIELD OF THE INVENTION

The present invention relates to wheelchairs and methods of using wheelchairs at security checkpoints.

### BACKGROUND OF THE INVENTION

The movement of people with disabilities in traditional metallic wheelchairs, including those people who need transport assistance within the airport terminal environment, is notoriously slow. One specific bottleneck within the airport environment is at the passenger screening checkpoint. At the checkpoint, all passengers are required to divest themselves of metal objects and walk through a metal detector. For people confined to wheelchairs, this process presents several challenges. For example, if the person is unable to walk unassisted, they cannot successfully pass through the metal detector in a metal wheelchair. Although special screening stations are available for travelers with special needs, the screening process is still time consuming, stressful, and inconvenient for both the disabled individual and Transportation Security Administration or other security personal.

FIG. 1 is a flow diagram of the steps a disabled passenger must go through to when entering an airport and traveling through the required security checks. In general, as indicated, a passenger utilizes a wheelchair to travel to the security checkpoint, as in step S1. In this step, a passenger may obtain a wheelchair from various unsecure locations in an airport. The passenger might then check in at a skycap curb or ticket counter. If required, the traveler is assisted into a wheelchair by the skycap or customer service agent. The Airport Passenger Assistant is contacted to assist the traveler to the gate, or the traveler is assisted by a family member.

The traveler travels to the gate security checkpoint, where an ID check is performed. The traveler then moves to the divesting tables. The traveler's items are divested into tubs for inspection by the TSA and X-ray equipment. From this point, the average wait time for the disabled passenger becomes lengthy as the wheelchair is screened in a separate area while the passenger stands and waits. In order to pass through the security checkpoint, the passenger and the wheelchair are separated. Thus, the passenger travels through the security checkpoint separate from the wheelchair, as in step S2. For example, the wheelchair passenger is assisted to a standing position and is instructed to walk (if possible) through a metal detector. Should an alarm be generated, he or she is given a second chance to divest any remaining items and is directed to re-enter the metal detector a second time. Note that the passenger must move through the metal detector unassisted which increases the amount of standing/unassisted walking time. Should a second alarm occur, the person is subject to a secondary TSA screening per standard operating procedures.

While the passenger is being screened, the wheelchair is separately moved through the security checkpoint, as in step S3. For example, the Passenger Assistant may move the wheelchair to an exit lane or through the ADA access lane for screening. The Passenger Assistant returns to the divesting table and places his or her personal items into a bin. The Passenger Assistant proceeds through the metal detector. Should an alarm be generated by the Passenger Assistant, he or she is also given a second chance to divest any remaining items and is required to pass through the metal detector for a second time. The Passenger Assistant retrieves his or her personal belongings, as well as the wheelchair passenger's personal belongings, if required.

Finally, once the passenger and wheelchair have separately moved through the security checkpoint, the passenger and wheelchair are united at the checkpoint exit, as in step S4. For example, the Passenger Assistant retrieves the screened wheelchair and assists the disabled person back into the wheelchair, proceeding to the departure gate.

The average time required to complete this standard security checkpoint screening operation for a traveler or event patron confined to a wheelchair is nine (9) minutes from the divesting tables to the exit of the checkpoint. During this process, the disabled traveler or event patron is required to stand for much of the time. This is problematic if the disabled traveler or event patron is not able to stand. For persons, security personnel often attempt to search the patron while they are seated in the wheelchair which creates a security threat if missed at the security checkpoint.

Aside from the inconvenience and difficult associated with this process, use of standard wheelchairs poses high security risks. Standard wheelchairs have countless cavities or areas that can be used to conceal hazardous objects or explosive materials, such as for passage through a security checkpoint. The metal frame of a standard wheelchair is typically made of hollow metal tube stock and the wheelchair includes numerous complex moving parts, some used to collapse the wheelchair. Small items can be placed inside the metal tubing or in between pieces of the fabric used for the seat and seatback. Each cavity and crevice poses a security risk.

These same problems are encountered in environments other than airports. One such environment is a large stadium hosting a sporting event such as a football game, baseball game, automobile race, or concert. Often times these events have security and metal detectors requiring each patron to go through a security checkpoint to insure event security.

The standard metallic wheelchair has other deficiencies as well. From a safety standpoint, when a large person sits in a standard wheelchair the wheels can rub against the person's clothing or body and cause friction burns. Additionally, the large wheels on the rear of standard wheelchairs are designed to allow people sitting in the chair to self propel the chair. In an airport environment, it is not necessarily desirable for passengers to self propel. For instance, if the person hits someone or something, or causes an accident with the traveling public, liability for damages or injuries becomes the airport's, airline's and/or Passenger Assistance Company's responsibility.

In a traditional hospital environment, the metallic wheelchair collects germs throughout the day and fosters the growth of bacteria and other undesired microbes requiring frequent cleaning and sterilization. In a fast paced environment such as a hospital, insuring that a wheelchair is sterilized after use by each patient becomes a critical procedural challenge. As such there is no systematic process in such environments other than medical personal remembering to disinfect the traditional wheelchair manually after use from one patient to the next.

Some efforts have been made to develop non-metallic wheelchairs, such as described in U.S. Pat. No. 7,182,256 and U.S. Pat. No. 6,786,496. However, these designs do not address the above stated limitation, including those associated with convenience, safety, and security.

### SUMMARY OF THE INVENTION

Aspects of the invention include an improved wheelchair and a method of security screening a wheelchair.

In one embodiment of the invention, a wheelchair is constructed of a non-metallic material, preferably of molded plastic. An antimicrobial agent is associated with the material, such as injected to the plastic. The wheelchair is designed without cavities to prevent items from being hidden in the wheelchair. The wheelchair also includes a plurality of safety features.

In a method of security screening, a wheelchair is tested for compliance with safety and security standards. The safety and security standards preferably require that the wheelchair be configured to pass through a security checkpoint screening device.

If compliant, the wheelchair is certified by locating certification information on the wheelchair and the wheelchair is provided for use. The certification information may comprise a printed or coded sticker.

Before each use, the wheelchair is validated by confirming the existence of the certification information. The wheelchair is then used to transport a user to and through a security checkpoint. Importantly, the method of the invention permits the user to remain seated in the wheelchair as the user and wheelchair passes through checkpoint screening.

Further objects, features, and advantages of the present invention over the prior art will become apparent from the detailed description of the drawings which follows, when considered with the attached figures.

### DESCRIPTION OF THE DRAWINGS

FIG. 1 is a flow diagram of a method of using a wheelchair at a security checkpoint in accordance with the prior art;

FIG. 2 is a perspective view of a wheelchair in accordance with the invention;

FIG. 3 is a rear view of the wheelchair illustrated in FIG. 2; and

FIG. 4 is a flow diagram of a method of using a wheelchair at a security checkpoint in accordance with the present invention.

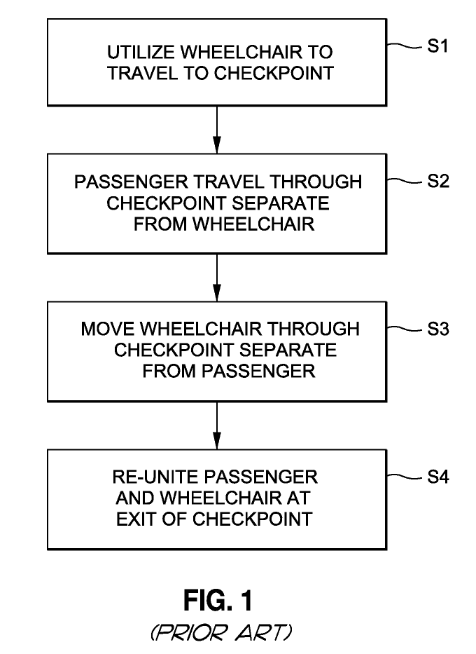

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is an improved wheelchair. Other embodiments of the invention comprise a method of security screening a wheelchair and associated passenger.

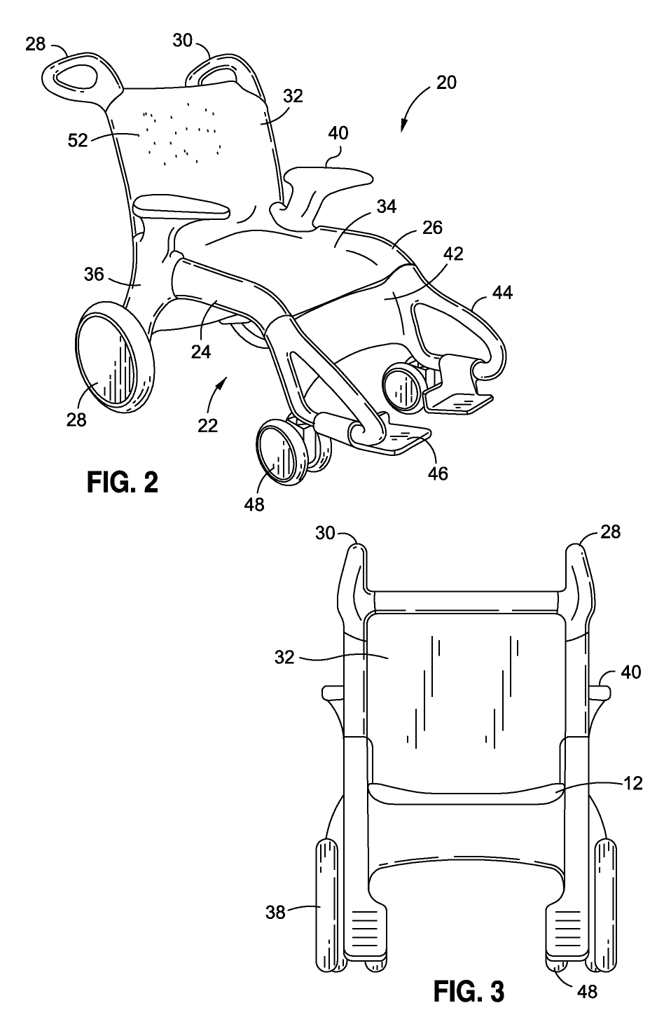

One embodiment of a wheelchair in accordance with the invention is illustrated in FIG. 2. The wheelchair is referenced herein as a RAMobility wheelchair. As indicated below, this wheelchair may be used in accordance with the security system and method of the invention.

In one embodiment, the wheelchair 20 is constructed entirely of plastic materials and components, preferably has a symmetrical configuration, and may be constructed in a variety of sizes for children and adults. Referring to FIG. 2, in one embodiment the wheelchair 20 comprises a frame or body 22. The frame 22 has left and right substantially horizontal members 24,26 which are spaced apart. A seat 34 is defined between the left and right horizontal members 24,26.

Left and right upper vertical members 28,30 extend generally upwardly from a rear portion of the left and right side horizontal members 24,26. The left and right upper vertical members 28,30 also extend slightly rearwardly, in an effort to provided stability to the overall design. The left and right upper vertical members 28,30 preferably define handles at the top portions thereof. A seat back 32 is defined between the left and right upper vertical members 28,30. The seat back 32 and seat 34 preferably connect or flow together to form a contiguous surface.

Legs 36 extend downward from a rear portion of the body 22. In one embodiment, a rear wheel 38 is located at the distal end of each leg 36. An arm rest 40 is located at a proximal end of each leg 36.

Preferably, a front support panel 42 extends downwardly from a front portion of the seat 26. The front support panel 42 may have frame members 44 located at opposing sides thereof for support and stiffness. A footrest 46 may be mounted to each frame member 44. Each footrest 46 may define a foot-supporting platform and be configured so that the platform can be rotated between a raised position (wherein the platform extends generally vertically) and a lowered, use position (in which the platform extends generally horizontally). Front wheels 48 are preferably located at opposing sides of a lower portion of the front support panel 42.

Additional details of a configuration of such a wheelchair may be found in U.S. Pat. No. 6,789,496, which is owned by the assignee of the present application, and which patent is incorporated herein by reference in its entirety.

Preferably, the wheelchair 20 is constructed from plastic or similar material in a molding process. In a preferred embodiment, during the manufacturing process, an antimicrobial or similar agent 52, such as described in U.S. Pat. No. 5,882,667, is added to the plastic. The agent might be added to the plastic before it is molded, or as a surface treatment after formation of the wheelchair. Preferably, the antimicrobial or similar agent is configured to resist or prevent the growth of microbes in or on the surfaces thereof.

One advantage of the wheelchair of the invention is that it is easy to clean and maintain in a sterile condition. First, when constructed from molded plastic, the wheelchair has smooth and continuous surface which can easily be wiped or sprayed clean. This is contrary to existing wheelchairs that have many component parts which are assembled at various angles and include various connections, resulting in joints, corners and other areas which can not readily be accessed. This allows germs to grow and prevents those areas from being cleaned.

In addition, the construction of the wheelchair with an antimicrobial agent further reduces the risk of contamination, such as might occur if the wheelchair were immediately used following the use by an infected patron.

Another advantage of the RAMobility wheelchair is that it is more secure. Because the wheelchair is formed from a single piece of sealed, molded plastic making it impossible to insert objects or explosive materials into the frame or other parts of the chair. The seat and seat back are ergonomically correct and integrated into the structural unit of the chair, so there is no need to remove or replace them on an individual basis. The chair is small enough to fit through a metal detector, yet large enough to allow a large person to be seated comfortably. The rear wheels are small and out of the reach of the seated passenger to prevent self propelling. The smaller wheels also eliminate the potential for the wheels to make contact with or injure the seated passenger.

Additionally, the RAMobility wheelchair includes two design elements to protect both the operator and passenger from injury during use. In one embodiment, as illustrated in FIG. 3, the left and right vertical members 28,30 have a footpad 50 at a bottom portion thereof. The footpad 50 comprises a foot engaging surface formed as an extended sweep that allows the operator to apply pressure on the back of the chair with his or her foot, allowing the front of the chair to be easily lifted and maneuvered across rough terrain or over a curb. Second, built-in handholds enable two people to lift the chair, providing load balance and reducing the chance of an accident during the transport process. Enabling two people to easily lift a chair ensures that no one person is supporting all of a passenger's weight, making the lift safer for both the passenger and the operators.

Another aspect of the invention is a method of security screening a wheelchair. The method has particular applicability to the RAMobility wheelchair. An important improvement provided by the invention is that the method eliminates the need for a wheelchair passenger to stand or walk unassisted.

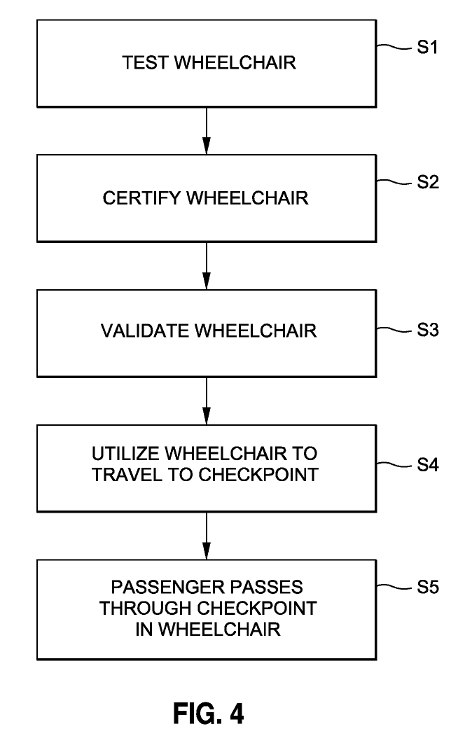

One method of the invention will be described with reference to FIG. 4. Such a method is particularly relevant to security screening at an airport or similar location.

Importantly, in a step S1, prior to deployment, the wheelchair is preferably tested to meet defined safety and security standards set by the manufacturer, regulator or other approval entity. In one embodiment, the wheelchair must be secure (no cavities or areas where items may be hidden) and safe (stable, configured to be readily cleanable and resistant to germs, etc.). The RAMobility wheelchair of the invention is one example of a wheelchair meeting such desired standards.

In a step S2, the wheelchair certified for use. In one embodiment, this may comprise securing a certification sticker on the wheelchair in a clearly visible location such as on one of the handles used to push the wheelchair. Of course, if the wheelchair does not meet the required standards, it is not certified. The certification may also comprise a certification for use at a particular location, such as identification of a particular wheelchair for use at a particular airport or the like. In this regard, a variety of certification information may be associated with the wheelchair. This information might comprise an airport code, service date, certification code or the like. Such information might be associated with printed media, such as text or a barcode printed on a sticker. However, the information might be associated with the wheelchair in other manners, such as via an RFID tag or the like.

In a step S3, prior to use by a wheelchair passenger, the wheelchair is preferably validated. This may comprise validating that the wheelchair is certified, such as by ensuring that the certification sticker is present. The validation might comprise other steps, however. For example, the certification might include verification of the certification information, such as determining that the wheelchair is being used in the location it is certified for use at. Such certification might be performed manually, such as by inspecting the wheelchair. It might also be performed in a partially automated fashion, such as by scanning a barcode and verifying that coded information (for example, a Passenger Assistant might carry a wireless bar code device permitting the scanning of such information). If the wheelchair is not validated, it is not used. This prevents passengers from attempting to use wheelchairs from other locations which might not meet the required safety and security standards.

In a step S4, the passenger uses the wheelchair to travel to the security checkpoint. In one embodiment, the passenger may check in at a skycap curb or ticket counter. The ticketing agent or skycap may contact an airport Passenger Assistant to assist the wheelchair passenger to the gate.

In one embodiment, certain safety procedures are employed when using the wheelchair. For example, relative to the RAMobility wheelchair of the invention, the Passenger Assistant preferably ensures that the RAMobility wheelchair footrests are in the stowed/upright position and that wheelchair wheel locks are engaged. Once the wheelchair is secure, the Passenger Assistant assists the passenger into the wheelchair. The Passenger Assistant may then deploy the footrests and position the passenger's feet securely on the footrests.

The Passenger Assistant may also discuss safety information with the passenger. For example, the passenger may be told to: (1) not to lean forward in the chair, as this movement can cause tipping; (2) not to lean over the back of the chair, as this movement can cause tipping; and (3) not attempt to tip the wheelchair while seated, as this movement can cause injury.

The Passenger Assistant may prepare and load carry on baggage for transport to the security screening checkpoint with the passenger. At that point, the Passenger Assistant may place the wheel locks into an unlocked position and then navigate the passenger safely to the security checkpoint.

Importantly, in accordance with the invention, the passenger passes through the security checkpoint while still seated in the wheelchair, as in step S5. In one embodiment, upon reaching the security checkpoint, the passenger's ID may be checked and then passenger may be directed to the divesting tables. The Passenger Assistant may retrieve one or more plastic bins for the passenger's belongings and assist the passenger in placing their personal items in to the bins or onto the X-ray or other security screening beltway. The Passenger Assistant may also assist the passenger in removing his or her shoes and then ensure that the passenger's feet are again properly positioned on the footrests.

Preferably, if the passenger has any removable medical devices or equipment, these items are placed into the plastic bin or the screening beltway last. This process ensures that the passenger has these devices available as long as possible, and minimizes the amount of time they are without the device. Of course, the passenger may comply with such other directives and rules provided at the security checkpoint.

The Passenger Assistant also divests any of his own items that may generate an alarm or as otherwise required by security rules and personnel. In a preferred embodiment, the Passenger Assistant passes through the metal detector or other screening to ensure that any alarms generated by the Passenger Assistant AND passenger as they pass through the screening together are the result of the passenger

Most importantly, the Passenger Assistant pushes the passenger through the metal detector or other screening while the passenger is still seated in the wheelchair. As indicated below, this saves substantial time and prevents a disabled passenger from having to attempt to walk through the checkpoint.

Once the passenger has passed through the securing screening, the Passenger Assistant maneuvers the wheelchair with the passenger into an out-of-the-way spot. The Passenger Assistant places the wheel locks into the locked position. If no alarms were generated, the passenger and/or Passenger Assistant gather all divested items from the conveyor and deposits them next to the wheelchair for safe keeping. The Passenger Assistant may deliver the bins to the passenger, allowing the passenger to immediately to remove any medical devices or equipment that may have been divested. The passenger may repack any electronic items or liquids that were removed prior to the X-ray screening. The Passenger Assistant may also assist the passenger with putting on his or her shoes and then again ensure that the passenger's feet are again properly positioned on the footrests.

Once all of the passenger's items have been retrieved, the Passenger Assistant places the wheel locks into the unlocked position and prepares the baggage and passenger for transport. The Passenger Assistant pushes both the baggage and the passenger to the departure gate.

In the event a screening alarm is generated, the wheelchair passenger and/or the Passenger Assistant may be provided with a second chance to divest any remaining items and be required to pass through the metal detector or other screening a second time. Again, during this process, the wheelchair passenger remains seated in the wheelchair. Should a second alarm be generated, the passenger and/or the Passenger Assistant may be subject to a secondary screening procedure per standard operating procedures of the venue or event.

Of course, the particular steps and/or order of the steps of the method may vary, such as dependent upon the particular rules and devices utilized at the security checkpoint, the configuration of the airport and the like. Regardless, however, in accordance with the invention the passenger is permitted to pass through the security checkpoint while still seated in the wheelchair.

As indicated above, the average time required to complete standard screening operations for a traveler confined to a wheelchair is nine (9) minutes from the divesting tables to clearing the backside of the checkpoint. During this process, the disabled traveler is required to stand for much of the time. In accordance with the invention, this time can be reduced to less than one (1) minute, and as low as 30 seconds, when the passenger has a limited amount of additional luggage or items needing divesture.

It will be appreciated that the method of the invention may be applied to other environments. For example, the method may be applied to use and security screening of a wheelchair and passenger at other locations, such as a concert venue. In such event, the user of the wheelchair may be directed to other types of ticketing counters, may be required to provide other types of IDs, and may undergo other types of security screening.

In one embodiment, a wheelchair user may utilize a personal wheelchair to travel into an airport or other venue. Preferably, at that point the user obtains a validated wheelchair for use at the airport or other location.

It will be appreciated that the term “Passenger Assistant” as used herein may refer to various parties. For example, at an airport, such personnel may be employed by an airline or the airport for specific aid to disabled passengers. Similar parties may be employed or provided at other locations. In accordance with the method, more than Passenger Assistant may aid the passenger. For example, one Passenger Assistant might transport the passenger from the ticketing counter to the security checkpoint, while another might escort the passenger through the security checkpoint. Yet another Passenger Assistant might transport the passenger to the gate.

In one embodiment of the invention, a wheelchair validation may be performed at the security checkpoint. For example, the wheelchair may be examined at the checkpoint for a certification sticker or tag. In another embodiment, a scanner might be employed to read information from the wheelchair as it passes through the checkpoint. The information may be compared to a database of stored information to confirm that the wheelchair has been certified for use at that particular location.

The testing, certification and validation steps of the invention have numerous advantages. First, testing with defined standards ensures that only wheelchairs which are safe and secure can be used at a secure location. Second, certification enables a user of the wheelchair to confirm that the wheelchair has been authorized for use. The validation confirms the certification. This prevents, for example, a terrorist from substituting a like wheelchair for a certified wheelchair and attempting to use that wheelchair to move illegal materials through the checkpoint. In particular, without the certification, such an “imposter” wheelchair can not be validated. The wheelchair can then be confiscated and taken to security so that it is not used and can not pass through the checkpoint.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of wheelchair security comprising:
providing a non-metallic wheelchair;
testing said wheelchair to confirm that said wheelchair conforms to predetermined standards of safety and security;
certifying said wheelchair if said wheelchair confirms to said predetermined standards, said step of certifying comprising the step of associating certification information with said wheelchair;
providing said wheelchair at a location where security screening is required;
validating said wheelchair before each use thereof, said step of validating comprising the step of confirming the existence of said certification information;
transporting a passenger through a security checkpoint in said wheelchair.

2. The method in accordance with claim 1 wherein said wheelchair is constructed from plastic.

3. The method in accordance with claim 2 wherein said wheelchair includes antimicrobial agent associated with said plastic, said agent comprising one of said standards of safety for said wheelchair.

4. The method in accordance with claim 1 wherein said step of certifying comprises placing a sticker on said wheelchair.
